(19) United States
(12) Patent Application Publication
(10) Pub. No.: US 2013/0276347 A1
(43) Pub. Date: Oct. 24, 2013

(54) FISHING LURE AND METHOD OF USE

(71) Applicant: Kenneth F. Jimenez, Mount Shasta, CA (US)

(72) Inventor: Kenneth F. Jimenez, Mount Shasta, CA (US)

(21) Appl. No.: 13/868,375

(22) Filed: Apr. 23, 2013

Related U.S. Application Data
(60) Provisional application No. 61/637,689, filed on Apr. 24, 2012.

(51) Int. Cl. A01K 85/14; A01K 99/00

(52) U.S. Cl. CPC A01K 85/14; A01K 99/00
USPC 43/4.5; 43/42.5; 43/42.49; 43/42.33

(57) ABSTRACT

An improved artificial fishing lure is provided that comprises a lure body with a hook attached to the rear end, a plurality of discs disposed along the body of the lure, and a spoon portion disposed at the front end of the body. The plurality of discs may be the type of discs traditionally used in fastening jewelry pins. The plurality of discs and the spoon portion of the artificial lure provide random movement through the water, as well as light reflection, to catch the attention of fish in the area.

### THE FIELD OF THE INVENTION

The present invention relates generally to fishing lures. More specifically, the present invention relates to an improved fishing lure for providing movement and light reflection in the water to attract fish.

### BACKGROUND

Fishing is a common pastime, both for the sport and the food it provides. According to the U.S. Fish and Wildlife Service's 2006 National Survey, 30 million people go fishing in the U.S. every year. In fishing, it is common to use either bait or an artificial lure, but artificial lures may be preferred for several reasons. First, artificial lures reduce the use of bait, thereby reducing the marine food web problem of overharvesting “bait” species which tend to occur lower in the food chain. Second, artificial lures reduce the incidence of deep hooking, correlated to fish mortality, and thus promote improved survival of fish during catch and release fishing. Because of these advantages, the use of artificial lures may be preferred in fishing.

However, artificial lures also have drawbacks. They are designed to resemble or otherwise mimic live bait. A drawback for many of these lures is that their movements may not attract fish when traveling through the water. Many attempts have been made to design artificial lures that exhibit action that is attractive to fish. For example, spoon lures are made to resemble the inside of a table spoon. They flash in the light while wobbling or darting due to their shape, and attract fish mainly by reflecting light and moving randomly. Various configurations have been attempted to achieve the reflection and random movement desired in an artificial lure, with varying rates of success. Lures are constantly being developed in an effort to seek more effective methods of attracting fish.

Thus there is a need for an improved fishing lure and method of using the same. The improved fishing lure should provide for random movement in the water to attract fish, as well as light reflection when moving through the water. It is also preferred that the lure be simple to construct and manufacture.

### SUMMARY OF THE INVENTION

The present disclosure provides an improved artificial fishing lure.

According to one aspect of the disclosure, an improved fishing lure is provided which may be configured for engagement to a fishing line, and which is simple in construction allowing for easy manufacturing.

According to another aspect of the disclosure, an improved fishing lure is provided which is comprised of a spoon portion, a body, and a front and rear end.

According to another aspect of the disclosure, the body of the lure comprises a plurality of discs, the discs having reeded edges along their circumference. The plurality of discs may be comprised of threaded nuts that are commonly used as fasteners for jewelry, pins, etc., to hold them to the jackets and the like.

According to another aspect of the disclosure, an improved artificial lure may include an additional member disposed along the body to improve movement and reflection through the water to attract fish.

According to still another aspect of the disclosure, the spoon portion of the fishing lure is generally shaped as an elongated oval and may be provided with a generally circular indentation on one end of the oval.

According to another aspect of the disclosure, the front end may be configured for connection to a fishing line, and the rear end may be configured for attachment to a hook.

According to another aspect of the present disclosure, the hook may be provided with any of a various number of the discs. The greater number of discs provided, the faster the lure will sink in use. Thus, for example, a lure may be used with 3 or 4 discs when fishing near the surface, 5-6 disks when fishing several feet below the surface and 7 or more discs when fishing still deeper.

According to yet another aspect of the present disclosure, a method of using an improved artificial lure may include selecting a lure according to the present disclosure, attaching the lure to a fishing line on the front end, and attaching a hook on the rear end. The method may also include using two or more lures in conjunction. The method may also include moving the lure through the water, such as by trolling or by reeling in the fishing line, etc.

These and other aspects of the present disclosure may be realized in an improved fishing lure which may be used to attract fish by its random movements and light reflection through the water as shown and described in the following figures and related description.

### BRIEF DESCRIPTION OF THE DRAWINGS

Various embodiments of the present invention are shown and described in reference to the numbered drawings wherein:

FIG. 1 shows a right side view of a fishing lure disclosed herein;

FIG. 2 shows a top view of a spoon portion according to the disclosure;

FIG. 3A shows a side view of a disc according to the disclosure;

FIG. 3B shows a top view of the disc of FIG. 3A;

FIG. 3C shows a perspective view of the disc of FIG. 3A;

FIG. 4 shows a left side view of the fishing lure of FIG. 1;

FIG. 5A shows a front view of the fishing lure of FIG. 1; and

FIG. 5B shows a back view of the fishing lure of FIG. 1.

It will be appreciated that the drawings are illustrative and not limiting of the scope of the invention which is defined by the appended claims. The configurations shown accomplish various aspects of the invention. It is appreciated that it is not possible to clearly show each element and aspect of the invention in a single FIGURE, and as such, multiple figures are presented to separately illustrate the various details of the invention in greater clarity. Similarly, not every embodiment need accomplish all advantages of the present invention.

### DETAILED DESCRIPTION

The invention and accompanying drawings will now be discussed in reference to the numerals provided therein so as to enable one skilled in the art to practice the present invention. The skilled artisan will understand, however, that the apparatuses, systems and methods described below can be practiced without employing these specific details, or that they can be used for purposes other than those described herein. Indeed, they can be modified and can be used in conjunction with products and techniques known to those of skill in the art in light of the present disclosure. The drawings and descriptions are intended to be exemplary of various aspects of the invention and are not intended to narrow the scope of the appended claims. Furthermore, it will be appreciated that the drawings may show aspects of the invention in isolation and the elements in one FIGURE may be used in conjunction with elements shown in other figures.

Reference in the specification to “one embodiment,” “an embodiment,” “one configuration,” or “a configuration” means that a particular feature, structure, or characteristic described may be included in at least one embodiment or configuration, but is not a requirement that such feature, structure or characteristic be present in any particular embodiment or configuration unless expressly set forth in the claims as being present. The appearances of the phrase “in one embodiment” or “in one configuration” in various places may not necessarily limit the inclusion of a particular element of the invention to a single embodiment or configuration, rather the element may be included in other or all embodiments or configurations discussed herein.

Furthermore, the described features, structures, or characteristics of embodiments of the invention may be combined in any suitable manner in one or more embodiments. In the following description, numerous specific details are provided, such as examples of products or manufacturing techniques that may be used, to provide a thorough understanding of embodiments of the invention. One skilled in the relevant art will recognize, however, that embodiments of the invention may be practiced without one or more of the specific details, or with other methods, components, materials, and so forth. In other instances, well-known structures, materials, or operations are not shown or described in detail to avoid obscuring aspects of the invention.

Before the present invention is disclosed and described in detail, it should be understood that the present disclosure is not limited to any particular structures, process steps, or materials discussed or disclosed herein, but is extended to include equivalents thereof as would be recognized by those of ordinarily skill in the relevant art. More specifically, the invention is defined by the terms set forth in the claims. It should also be understood that terminology contained herein is used for the purpose of describing particular aspects of the invention only and is not intended to limit the invention to the aspects or embodiments shown unless expressly indicated as such. Likewise, the discussion of any particular aspect of the invention is not to be understood as a requirement that such aspect is required to be present apart from an express inclusion of the aspect in the claims.

It should also be noted that, as used in this specification and the appended claims, singular forms such as “a,” “an,” and “the” may include the plural unless the context clearly dictates otherwise. Thus, for example, reference to “a spring” may include one or more of such springs, and reference to “the layer” may include reference to one or more of such layers.

As used herein, the term “substantially” refers to the complete or nearly complete extent or degree of an action, characteristic, property, state, structure, item, or result to function as indicated. For example, an object that is “substantially” enclosed would mean that the object is either completely enclosed or nearly completely enclosed. The exact allowable degree of deviation from absolute completeness may in some cases depend on the specific context, such that enclosing the nearly all of the length of a lumen would be substantially enclosed, even if the distal end of the structure enclosing the lumen had a slit or channel formed along a portion thereof. The use of “substantially” is equally applicable when used in a negative connotation to refer to the complete or near complete lack of an action, characteristic, property, state, structure, item, or result. For example, structure which is “substantially free of” a bottom would either completely lack a bottom or so nearly completely lack a bottom that the effect would be effectively the same as if it lacked a bottom.

As used herein, the term “about” is used to provide flexibility to a numerical range endpoint by providing that a given value may be “a little above” or “a little below” the endpoint while still accomplishing the function associated with the range.

As used herein, a plurality of items, structural elements, compositional elements, and/or materials may be presented in a common list for convenience. However, these lists should be construed as though each member of the list is individually identified as a separate and unique member.

Concentrations, amounts, proportions and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually. This same principle applies to ranges reciting only one numerical value as a minimum or a maximum. Furthermore, such an interpretation should apply regardless of the breadth of the range or the characteristics being described.

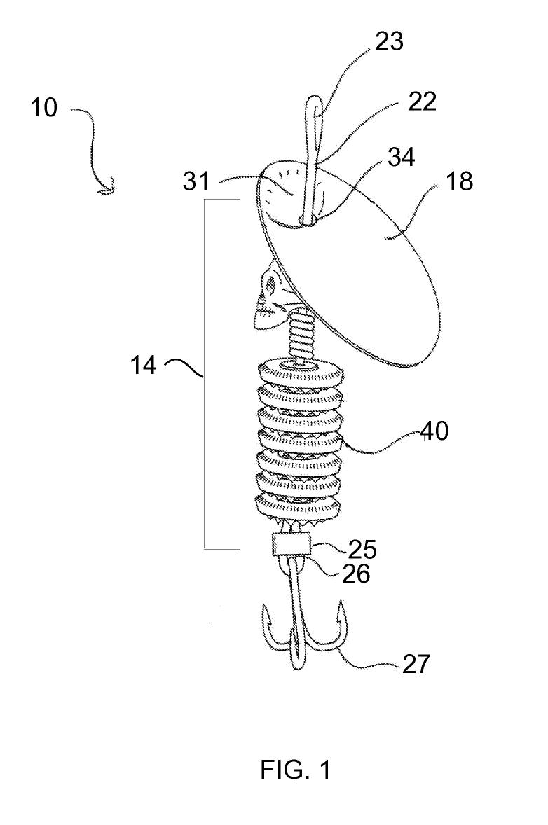

FIG. 1 shows a perspective, right-side view of a fishing lure according to the present disclosure generally indicated at 10. The fishing lure includes a lure body 14 and a spoon portion 18. The lure body may further comprise a plurality of discs 40. For the sole purpose of reference, the fishing lure will be referred to as having a front end 22 and a rear end 25. The front end 22 is the end of the lure that is typically attached to a fishing line. In FIG. 1, the lure body 14 defines a front end 22 that may include a front eyelet 23. Front eyelet 23 may be connected to a fishing line, for example, either directly by tying, or through a connector such as a snap or snap swivel (fishing line not shown for clarity).

The rear end 25 may be configured for attachment to a hook. In FIG. 1, the rear end includes a rear or lower eyelet 26. As seen in FIG. 1, the eyelet 26 is attached directly to a treble hook 27. A hook may also be attached to the eyelet 26 through a split ring, etc. One with skill in the art will appreciate that the eyelet 26 could also be attached to any type of hook known in the art, such as a single hook, double hook, etc.

The spoon portion 18 of the lure 10 may be a generally oval configuration. The size of the spoon portion may be any desired, but may be constructed of sizes that maximize random movement through the water without sacrificing speed. For example, a smaller size will decrease the resistance through the water, and thus increase speed, but will sacrifice random movement. A larger size will increase random movement through the water, but will be slower and more difficult to move through the water. One having skill in the art will appreciate that depending on the type of fish desired to be attracted by the lure under the circumstances, the spoon 18 may be constructed of varying sizes. Additionally, while FIG. 1 shows the spoon 18 being towards the front end 22 of the lure body 14, one having skill in the art will appreciate that the spoon 18 could be positioned at any point desired along the lure body 14. For example, the spoon 18 could be positioned nearer the rear end 25 of the lure body 14, or towards the middle of the lure body 14, etc.

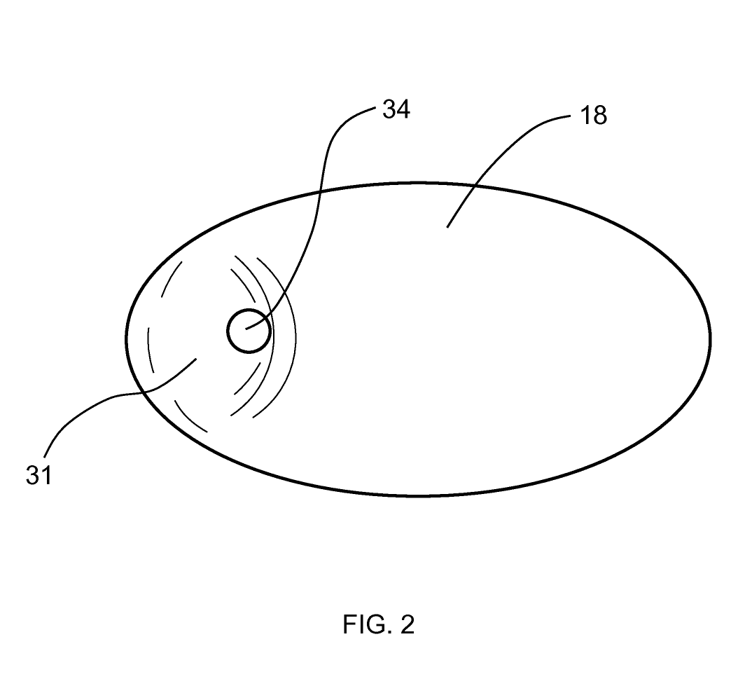

The spoon portion 18 may further include an indentation 31 towards one end of the generally oval surface, and a hole 34 for threading onto the body 14 of the lure. FIG. 2 shows a top view of the spoon portion 18. The indentation 31 may be generally circular in shape and may include a hole 34 disposed on the edge nearest the center of the spoon. The hole 34 allows the spoon to be threaded onto the body 14 of the lure 10. The generally circular indentation 31 may reduce the friction between the spoon portion 18 and the lure body 14 as the spoon portion 18 spins around the lure body 14. This may allow for greater freedom of movement of the spoon 18 around the body 14 of the lure, and may thus increase the spoon 18's random movement in the water.

The spoon portion 18 may be composed of any suitable material know in the art, such as metal, plastic, rubber, wood, and the like. According to one configuration, the spoon portion 18 may be formed of a highly reflective material, such as stainless steel or another reflective material, in order to increase light reflection to catch the attention of fish.

The body 14 of the lure may further include a plurality of discs 40. As shown in FIG. 1, the plurality of discs 40 comprises seven discs. One with skill in the art will appreciate that fewer discs or more discs could be used, depending on the desired outcome for the lure under a particular set of circumstances. Each disc 40 may be generally round in shape, and may include a hole in the center for threading the disc 40 onto the body 14 of the lure.

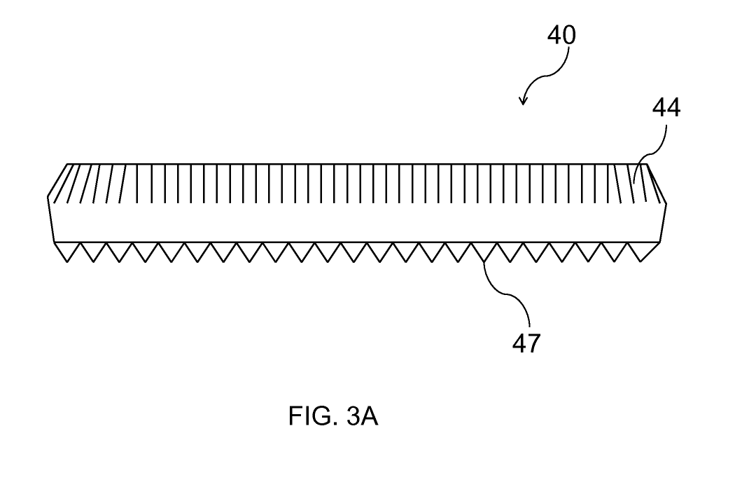

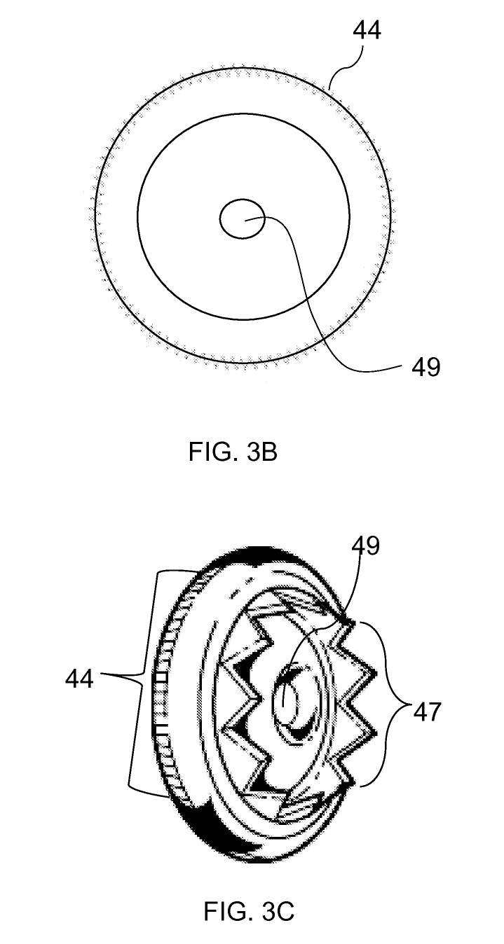

Turning now to FIG. 3A, there is shown a side view of one of the discs, generally indicated at 40. The top circumference of the disc may have a reeded edge 44. This reeding may improve deflection and random movement through the water. The bottom circumference of the disc 40 may include a plurality of spikes 47, or generally triangular protrusions. According to one configuration, the disc 40 may be of the type of disc that is a threaded nut and traditionally used as a fastener for jewelry pins.

Turning now to FIG. 3B, there is shown a top view of the disc 40 in FIG. 3A. The disc 40 may be provided with reeding 44 along the top circumference. In the center of the disc 40, a hole 49 may be provided for threading the disc 40 onto the body 14 of the lure 10. FIG. 3C shows a perspective view of the disc 40 shown in FIG. 3A. Standard discs already in manufacture (of the type traditionally used to fasten jewelry pins) may be thus threaded onto the body 14 of the lure. A disc like the one shown in FIGS. 3A-3C may be used, or any other disc for fastening jewelry. Additionally, discs traditionally used to fasten jewelry pins may be modified or specially manufactured for use on the lure. For example, in one configuration, the disc may be manufactured without its threads and with a smaller diameter hole 49.

The fishing lure 10 may use a single disc 40 along the body of the lure, or a plurality of discs along the body of the lure. Additionally, the discs 40 may be free to rotate independent of one another, or they may be attached to one another so as to rotate as a single body. One having skill in the art will appreciate that the number of discs used would depend on the particular circumstances and the outcome sought. Furthermore, the lure according to the present disclosure may also be varied by increasing or decreasing the size of the discs used. A smaller lure, which may be generally used for smaller fish, may include a disc having a smaller diameter disposed along the body of the lure. It may also use a smaller number of discs. A larger lure, which may be generally used for larger fish, may include a disc having a larger diameter disposed along the body of the lure, and may use more discs. In this manner, the fishing lure may be adapted to change the size of the discs and the number of the discs, without departing from the scope of the present disclosure.

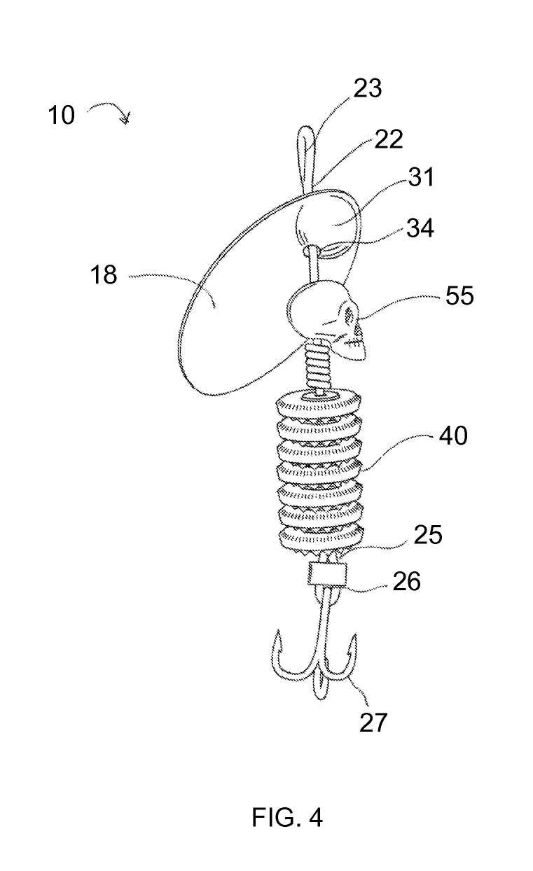

Turning now to FIG. 4, there is shown a left side view of the fishing lure 10 of FIG. 1. The body 14 of the lure 10 may include a spinning and/or light reflecting member 55. As shown in FIG. 4, this member 55 is shaped as a skull, but the member 55 may also be constructed of other shapes or sizes desired based on the needs for the lure. The member 55 may be integral to the lure body 14, or it may be formed with a hole extending through its axis, so that it may be threaded onto the body 14. Threading the member 55 may provide additional spinning movement of the lure, which may aid in the attraction of fish. The member 55 may be composed of any suitable material known in the art. The member 55 may be formed of a highly reflective material, to further catch light and attract the attention of fish. The lure body 14 may also include a bearing 59 disposed between the spoon portion 18 and the member 55. The bearing 59 may provide additional spinning action for the spoon portion 18 and/or member 55. The bearing 59 may be formed of metal tubing or any other suitable material known in the art, and may be formed of light-reflecting materials if desired.

There are many advantages according to the present disclosure that will be appreciated by one skilled in the art. The lure 10 has both a spoon portion 18 that may spin and reflect light as the lure moves through the water, and a plurality of discs 40 with reeding 44 that may also spin and reflect light as the lure moves through the water. This may increase the chance that the lure will catch the attention of fish in the area. An additional spinning/light reflecting member 55 may also be provided to increase the chance of attracting the attention of fish.

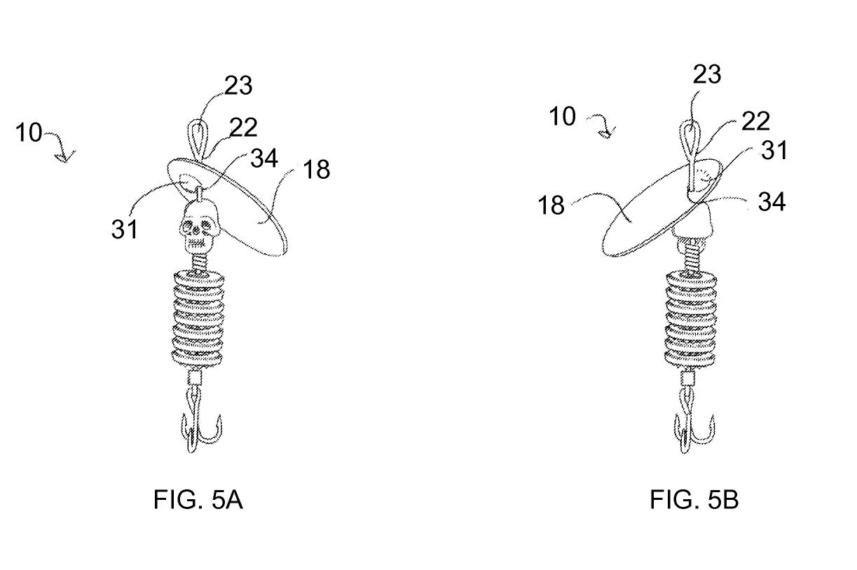

Turning now to FIGS. 5A and 5B, there are shown front and rear views, respectively, of the fishing lure of FIG. 1. As seen in FIGS. 5A and 5B, the generally oval-shaped spoon portion 18 may be provided with a generally circular indentation 31 towards one end. This indentation 31 may have a hole 34 provided along the circumference of the circle, and towards the center of the spoon 18. The hole 34 allows the spoon 18 to be threaded onto the body of the lure 14. It can be seen in these figures that the indentation 31 allows for a smaller portion of the spoon 18 to come into contact with the front end 22 of the lure body. In this manner, the friction between the spoon 18 and the lure body 14 may be reduced, and the spoon 18 may spin more easily.

In use, the angler would choose the appropriate fishing lure according to the present disclosure. The angler may choose a lure with fewer or more discs, discs with smaller or larger diameters, and smaller or larger spoons, depending on the type of fishing desired under the circumstances. The angler would then secure a hook to the rear eyelet 26 of the lure, and may attach other lures to be used in conjunction with the lure according to the present disclosure. Next, the angler would secure his fishing line to the front eyelet 23, and then begin to move the lure in the water. This may be accomplished, for example, by trolling or reeling in the fishing line. The spoon 18 and the discs 40 on the lure would assist the lure in moving randomly through the water and reflecting light so as to attract fish.

There is thus disclosed an improved fishing lure and method of using the same. It will be appreciated that numerous changes may be made to the present invention without departing from the scope of the claims.

What is claimed is:

1. A fishing lure comprising:
a lure body having a fishhook associated therewith;
a spoon portion connected to the lure body;
wherein the lure body comprises a disc, the disc having a hole therethrough for threading onto the lure body.

2. The fishing lure of claim 1, wherein the disc comprises a reeded edge.

3. The fishing lure of claim 1, wherein the body comprises a plurality of discs having holes therethrough for threading onto the lure body, and wherein the plurality of discs have reeded edges.

4. The fishing lure of claim 1, further comprising a light reflecting member disposed along the body of the lure.

5. The fishing lure of claim 4, wherein the light reflecting member is shaped as a skull.

6. The fishing lure of claim 1, wherein the fishhook is a treble hook.

7. An artificial fishing lure comprising:
a body defining a forward end and a rearward end;
means for attaching a fishing hook extending from the rearward end of the body;
means for attaching a fishing line extending from the forward end of the body;
a plurality of discs disposed along the body, wherein the plurality of discs is configured such that the plurality of discs catches the water as the artificial lure is pulled through the water to impart a motion that attracts fish.

8. The artificial fishing lure of claim 7, wherein the plurality of discs are comprised of discs with reeded edges.

9. The artificial fishing lure of claim 7, wherein the plurality of discs are comprised of discs traditionally used to fasten jewelry pins.

10. The artificial fishing lure of claim 7, further comprising a spoon portion disposed along the body of the lure.

11. The artificial fishing lure of claim 10, wherein the spoon portion is generally oval-shaped, defining a first end of the oval, a center of the oval, and a second end of the oval.

12. The artificial fishing lure of claim 11, wherein the spoon portion further comprises a generally circular depression defined by a circumference disposed on the first end of the oval.

13. The artificial fishing lure of claim 12, wherein the spoon portion further comprises a void disposed on a portion of the circumference of the generally circular depression, the portion of the circumference being located towards the center of the oval.

14. The artificial fishing lure of claim 7, wherein the spoon portion is composed of a material that will reflect light.

15. The artificial fishing lure of claim 7, wherein the plurality of discs is composed of a material that will reflect light.

16. A method of fishing with an artificial lure, the method comprising the steps of:
determining what type of fishing is desired;
determining the size requirements of the artificial lure for the fishing type desired;
selecting an artificial lure based on the size requirements, the artificial lure comprising:
a lure body defining a forward end and rearward end, the forward end having a front eyelet for connection to a fishing line and the rearward end having a rear eyelet for connection to a fishhook;
a generally oval spoon section threaded onto the lure body; and
a plurality of discs threaded onto the lure body, the plurality of discs being able to spin freely on the lure body;
attaching the front eyelet of the artificial lure to a fishing line;
attaching the rear eyelet of the artificial lure to a fishhook; and
moving the fishing line through the water.

17. The method according to claim 16, wherein the step of moving the fishing line through the water comprises trolling.

18. The method according to claim 16, wherein the method further comprises attaching the fishing line to a fishing pole.

19. The method according to claim 18, wherein the step of moving the fishing line through the water comprises reeling in the fishing pole.

20. The method according to claim 16, wherein the step of attaching the rear eyelet of the artificial lure to a fishhook further comprises attaching the rear eyelet to a treble hook.
